(19) United States
(12) Patent Application Publication
(10) Pub. No.: US 2008/0060256 A1
(43) Pub. Date: Mar. 13, 2008

(54) Mosquito Trap

(76) Inventors: Yue-Long Chu, Taipei (TW); Chia-Chang Hsu, Taipei (TW)

Correspondence Address: WHYTE HIRSCHBOECK DUDEK S C, 555 EAST WELLS STREET, SUITE 1900, MILWAUKEE, WI, 53202, US

(21) Appl. No.: 11/777,330

(22) Filed: Jul. 13, 2007

(30) Foreign Application Priority Data
Sep. 8, 2006 (TW) 095216040

(51) Int. Cl. A01M 1/10; A01M 1/02; A01M 1/14; A01M 1/22; A01M 1/06

(52) U.S. Cl. 43/107; 43/114; 43/112; 43/139

(57) ABSTRACT

A mosquito trap includes: a container defining an inner space therein and having a top opening in fluid communication with the inner space and adapted for entrance of mosquito therethrough and into the inner space; a perforated plate mounted in the container, dividing the inner space into first and second chambers, and formed with a plurality of apertures in fluid communication with the first and second chambers; and a carbon dioxide generating attractant disposed in the second chamber of the container.

### CROSS-REFERENCE TO RELATED APPLICATION

This application claims priority of Taiwanese Application No. 095216040, filed on Sep. 8, 2006.

### BACKGROUND OF THE INVENTION

1. Field of the Invention

The invention relates to a mosquito trap, more particularly to a mosquito trap including a carbon dioxide generating attractant disposed in a container and a perforated plate disposed in the container above the carbon dioxide generating attractant.

2. Description of the Related Art

FIG. 1 illustrates a conventional mosquito trap 3 that includes an open container 33 and a funnel-shaped restricting member 32 extending into the open container 33. A fermentable aqueous solution 34 is received in the open container 33 for producing carbon dioxide for attracting mosquito. The conventional mosquito trap is disadvantageous in that insects, such as flies, can be trapped and lay in the open container 33 and increase considerably in number through by accessing to the nutrition of the fermentable aqueous solution 34.

### SUMMARY OF THE INVENTION

The object of the present invention is to provide a mosquito trap that can overcome the aforesaid drawback associated with the prior art.

Accordingly, a mosquito trap of this invention comprises: a container defining an inner space therein and having a top opening in fluid communication with the inner space and adapted for entrance of mosquito therethrough and into the inner space; a perforated plate mounted in the container, dividing the inner space into first and second chambers, and formed with a plurality of apertures in fluid communication with the first and second chambers; and a carbon dioxide generating attractant disposed in the second chamber of the container.

### BRIEF DESCRIPTION OF THE DRAWINGS

Other features and advantages of the present invention will become apparent in the following detailed description of the preferred embodiments with reference to the accompanying drawings, of which:

FIG. 1 is a sectional view of a conventional mosquito trap;

FIG. 2 is a perspective view of the first preferred embodiment of a mosquito trap according to the present invention;

FIG. 3 is a sectional view of the first preferred embodiment;

FIG. 4 is a sectional view of the second preferred embodiment of the mosquito trap according to the present invention;

FIG. 5 is a sectional view of the third preferred embodiment of the mosquito trap according to the present invention;

FIG. 6 is a sectional view of the fourth preferred embodiment of the mosquito trap according to the present invention;

FIG. 7 is a perspective view of the fifth preferred embodiment of the mosquito trap according to the present invention;

FIG. 8 is a sectional view of the fifth preferred embodiment, illustrating a state where a lid is disposed at an opened position;

FIG. 9 is a sectional view of the fifth preferred embodiment, illustrating another state where the lid is disposed at a closed position;

FIG. 10 is a sectional view of the sixth preferred embodiment of the mosquito trap according to this invention;

FIG. 11 is a sectional view of the seventh preferred embodiment of the mosquito trap according to this invention, illustrating a state where a container is disposed at an expansion state;

FIG. 12 is a sectional view of the seventh preferred embodiment, illustrating a state where the container is disposed at a contraction state;

FIG. 13 is a schematic front view of the eighth preferred embodiment of the mosquito trap according to this invention, illustrating a state where a container is disposed at a folded state;

FIG. 14 is a schematic side view of the eighth preferred embodiment;

FIG. 15 is a perspective view of the eighth preferred embodiment, illustrating a state where the container is disposed at an extended state;

FIG. 16 is an exploded perspective view of the ninth preferred embodiment according to this invention.

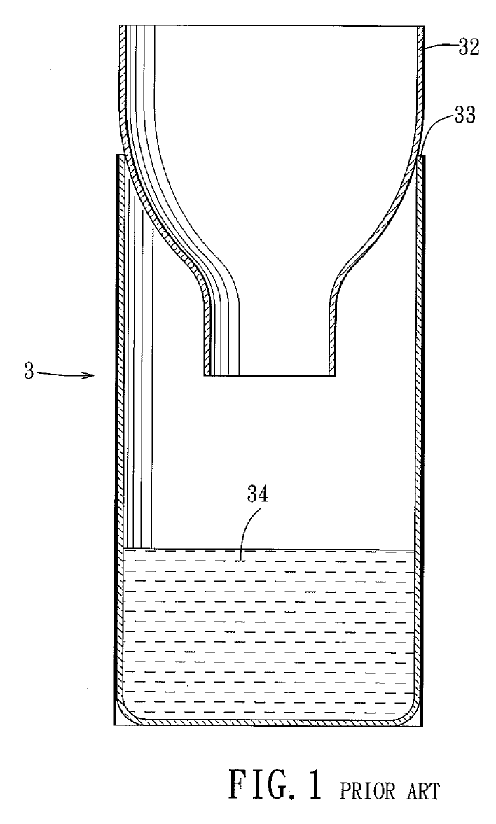

### DETAILED DESCRIPTION OF THE PREFERRED EMBODIMENTS

Before the present invention is described in greater detail with reference to the accompanying preferred embodiments, it should be noted herein that like elements are denoted by the same reference numerals throughout the disclosure.

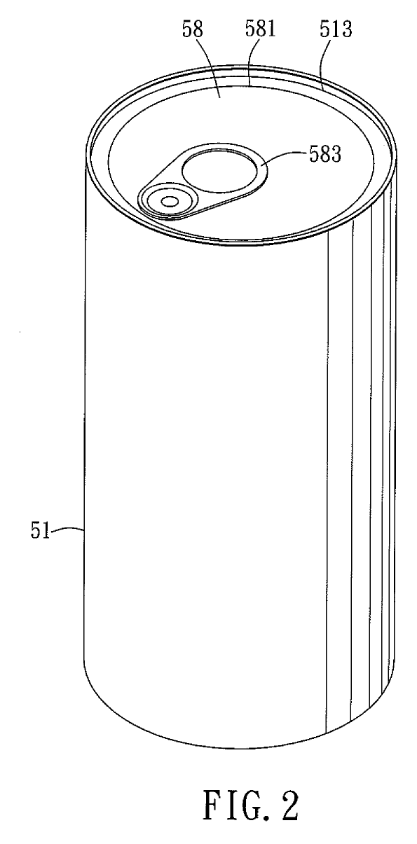

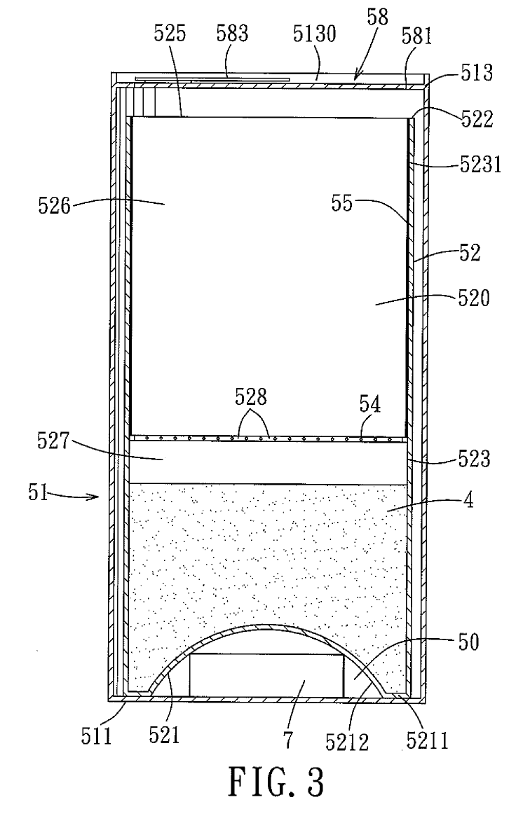

Referring to FIGS. 2 and 3, the first preferred embodiment of a mosquito trap according to the present invention is shown to include: a container 52 defining an inner space 520 therein and having a top opening 525 in fluid communication with the inner space 520 and adapted for entrance of mosquito therethrough and into the inner space 520; a perforated plate 54 mounted in the container 52, dividing the inner space 520 into first and second chambers 526, 527, and formed with a plurality of apertures 528 in fluid communication with the first and second chambers 526, 527; and a carbon dioxide generating attractant 4 disposed in the second chamber 527 of the container 52. Preferably, the carbon dioxide generating attractant 4 is a fermentable material when mixed with water. The perforated plate 54 serves to prevent insects from entering into the lower chamber 527 to access to the carbon dioxide generating attractant 4.

In this embodiment, the perforated plate 54 is in the form of a screen. The first chamber 526 in the container 52 is disposed above the second chamber 527 of the container 52. The container 52 further has a top open end 522 that defines the top opening 525, and an inner surface 523 having an upper portion 5231 disposed above the perforated plate 54 and coated with an adhesive 55.

In this embodiment, the mosquito trap further includes an outer can 51 and a heater 7. The container 52 is disposed in the outer can 51. The outer can 51 has a bottom wall 511. The container 52 has a bottom wall 521 that has a flat portion 5211 seated on the bottom wall 511 of the outer can 51, and a concave portion 5212 which extends from the flat portion 5211 and which cooperates with the bottom wall 511 of the outer can 51 to define a gap 50 therebetween. The heater 7 is disposed in the gap 50 for heating the carbon dioxide generating attractant 4, and is preferably in the form of a long lasting warmer pad containing a heat generating material which generates heat when triggered.

The outer can 51 further has an open end 513 opposite to the bottom wall 511 of the outer can 51 and defining a top opening 5130 of the outer can 51. The outer can 51 is in the form of an easy-to-open container, and further has a lid 58 connected removably to and extending inwardly from the open end 513 for covering the top opening 5130 of the outer can 51, an incision 518 formed between the lid 58 and the open end 513 of the outer can 51 so as to permit removal of the lid 58 from the outer can 51, and a pull ring 583 provided on the lid 58 so as to facilitate removal of the lid 58 from the outer can 51.

At least one of outer can 51 and the container 52 is preferably opaque.

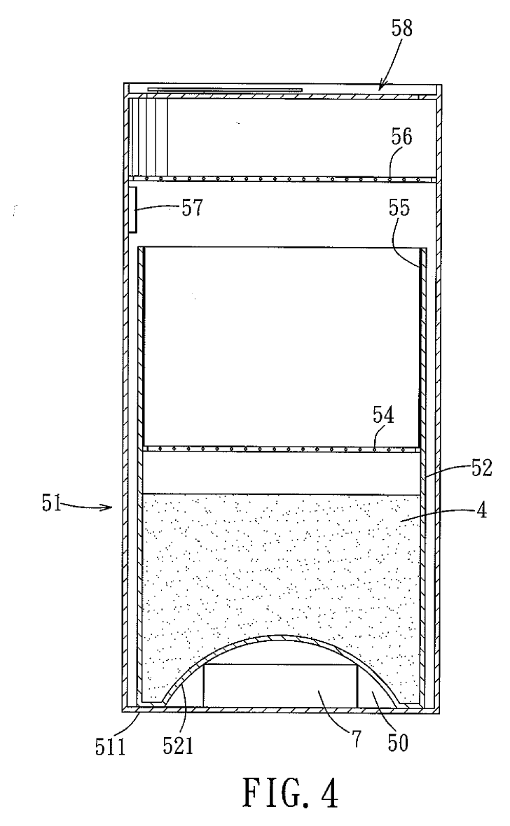

Referring to FIG. 4, the second preferred embodiment of the mosquito trap differs from the previous embodiment in that an electric capturing screen 56 is further incorporated therein. In this embodiment, the electric capturing screen 56 is mounted in the outer can 51 and is disposed above the container 52. A power supply unit 57 is mounted on an inner surface of the outer can 51 and is connected electrically to the electric capturing screen 56 so as to provide power to kill mosquito trapped on the electric capturing screen 56.

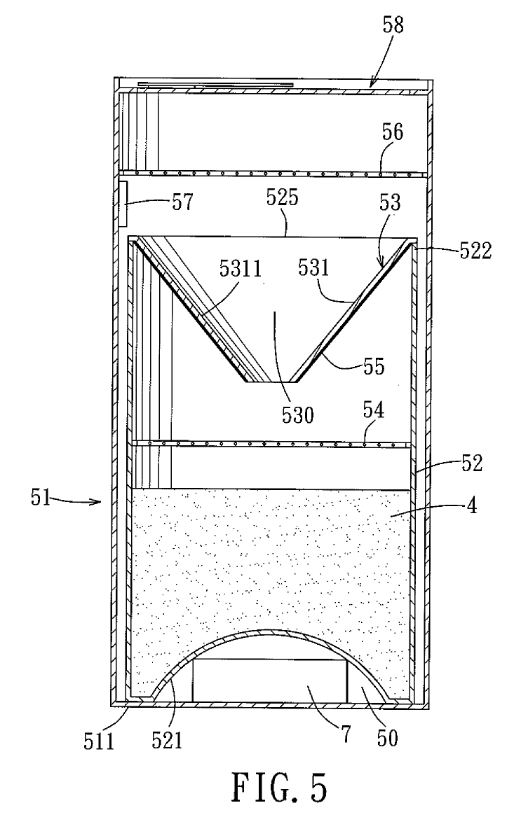

Referring to FIG. 5, the third preferred embodiment of the mosquito trap differs from the previous preferred embodiments in that a restricting member 53 is further incorporated therein. The restricting member 53 extends inwardly from the top open end 522 of the container 52 and defines a channel 530 that has a cross-section smaller than that of the top opening 525 and that is in fluid communication with the first chamber 526 in the container 52 and the top opening 525 of the container 52. In this embodiment, the restricting member 53 has a funnel shape and the channel 530 is reduced in cross-section from the top open end 522 of the container 52 so as to prevent mosquito from flying out of the container 52 once they are trapped inside.

In this embodiment, the channel 530 is defined by a channel-defining wall 531 that has an inner surface 5311 facing the perforated plate 54. The adhesive 54 is coated on the inner surface 5311 of the channel-defining wall 531.

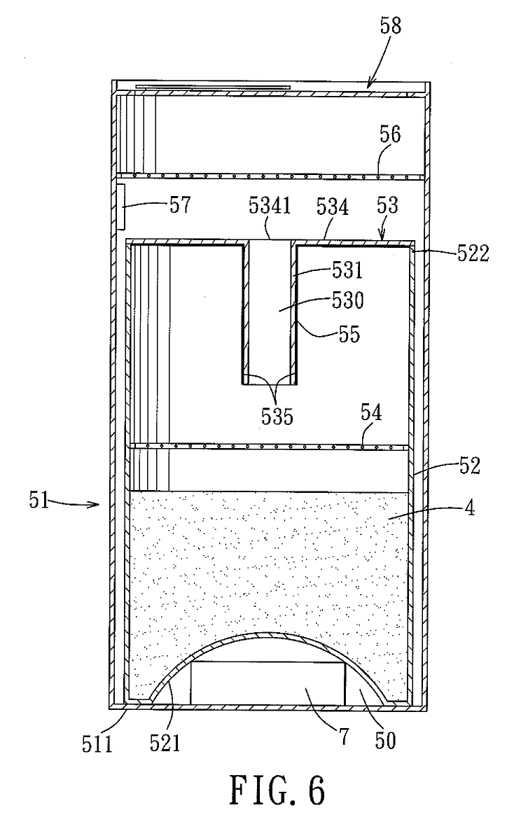

Referring to FIG. 6, the fourth preferred embodiment of the mosquito trap differs from the third preferred embodiment in that the channel-defining wall 531 is cylindrical in shape.

In this embodiment, the restricting member 53 of this embodiment has an annular flange 534 extending radially and inwardly from the top open end 522 of the container 52 and defining a central opening 5341. The channel-defining wall 531 extends axially from a periphery of the central opening 5341 of the annular flange 534. The adhesive 55 is coated on an inner surface 535 of the restricting member 53.

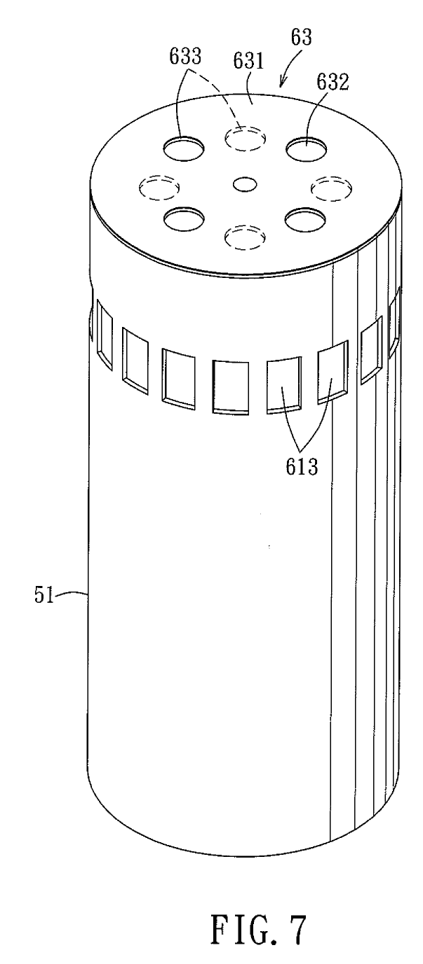

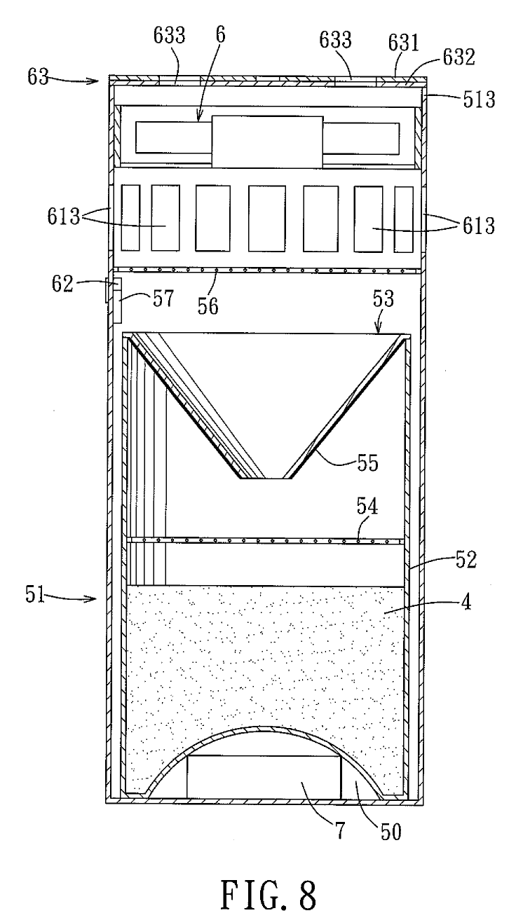

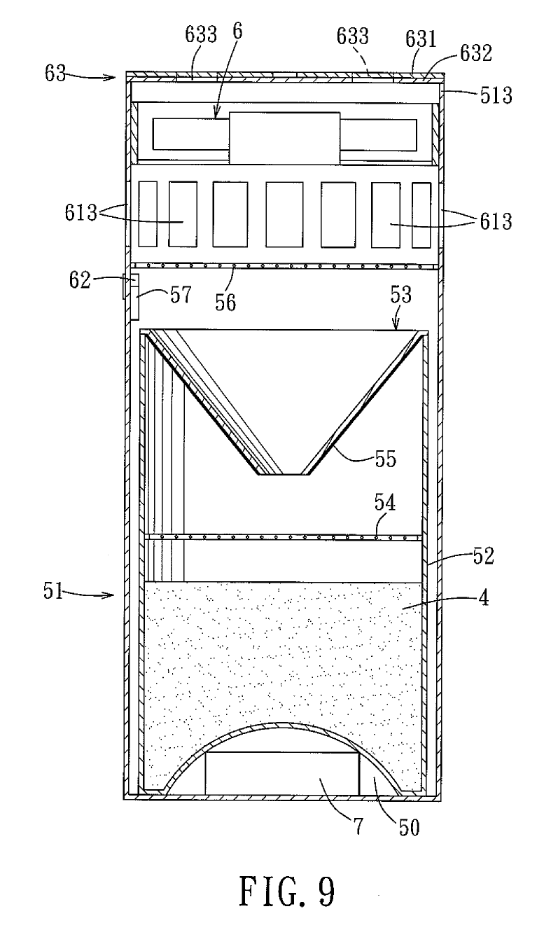

Referring to FIGS. 7, 8 and 9, the fifth preferred embodiment of the mosquito trap differs from the previous preferred embodiments in that a fan unit 6 is further incorporated therein. In this embodiment, the outer can 51 includes a lid 63 for covering and uncovering the top opening 5131 of the outer can 51. The lid 63 has upper and lower parts 631, 632 that overlap each other and that are rotatable relative to each other between opened and closed positions (see FIGS. 8 and 9). Each of the upper and lower parts 631, 632 is formed with a plurality of holes 633. The holes 633 in the upper part 631 are aligned with the holes 633 in the lower part 632 when the upper and lower parts 631, 632 are disposed at the opened position (see FIG. 8), and are misaligned with the holes 633 in the lower part 632 when the upper and lower parts 631, 632 are disposed at the closed position (see FIG. 9). A driving unit 62 is mounted on the inner surface of the outer can 51 and is connected to the upper and lower parts 631, 632 for driving movement of the upper and lower parts 631, 632 for opening and closing the lid 63. In this embodiment, the driving unit 62 is a motor.

The outer can 51 further has an upper end portion that is disposed above the container 52, and that is formed with a plurality of air inlet holes 613. The fan unit 6 is electrically connected to the power supply unit 57. In this embodiment, the power supply unit 57 is a battery unit. The fan unit 6 serves to increase spreading of generated carbon dioxide through the holes 633 in the upper and lower parts 631, 632 of the lid 63 and into the ambient atmosphere so as to enhance attraction of mosquito thereto. In addition to assisting the spreading of the generated carbon dioxide to the ambient atmosphere, the fan unit 6 also draws mosquito, flying around the air inlet holes 613 outside of the outer can 51, along with an air stream through the air inlet holes 613 into the outer can 51 upon actuation.

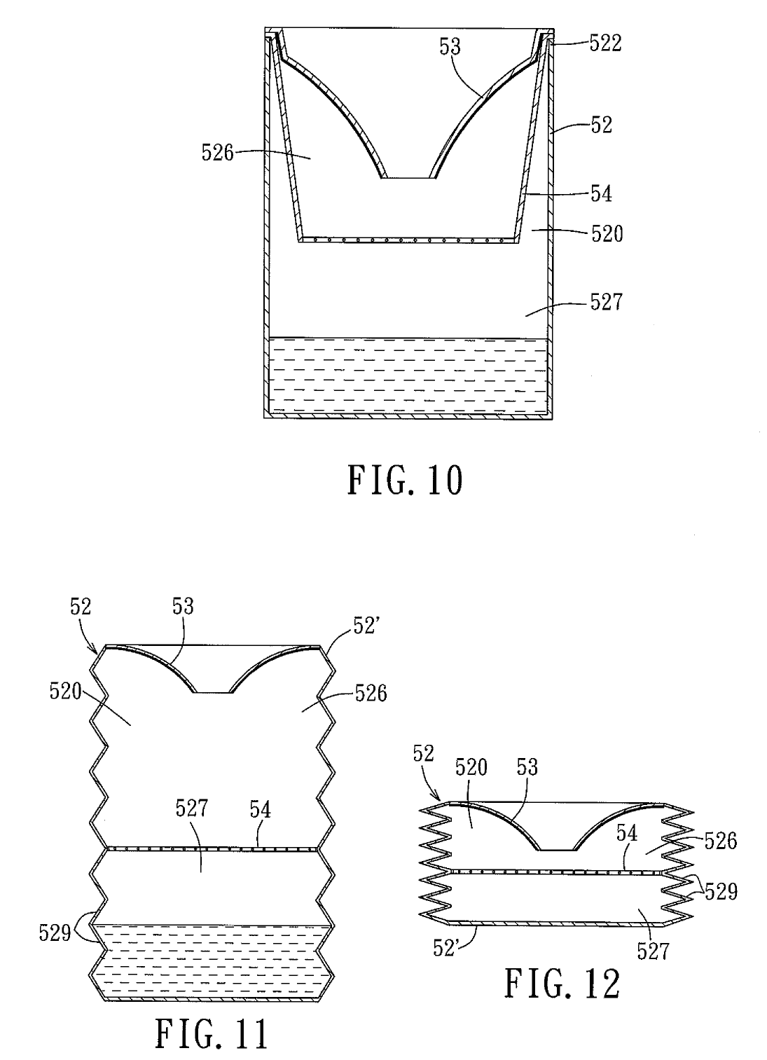

Referring to FIG. 10, the sixth preferred embodiment of the mosquito trap differs from the previous preferred embodiments in that the perforated plate 54 is generally U-shaped and extends from the top open end 522 of the container 52.

Referring to FIGS. 11 and 12, the seventh preferred embodiment of the mosquito trap differs from the previous preferred embodiments in that the container 52 includes a bellow wall body 52′ that defines the inner space 520 and that is formed with a plurality of pleated portions 529 so as to permit expansion (see FIG. 11) and contraction (see FIG. 12) of the container 52.

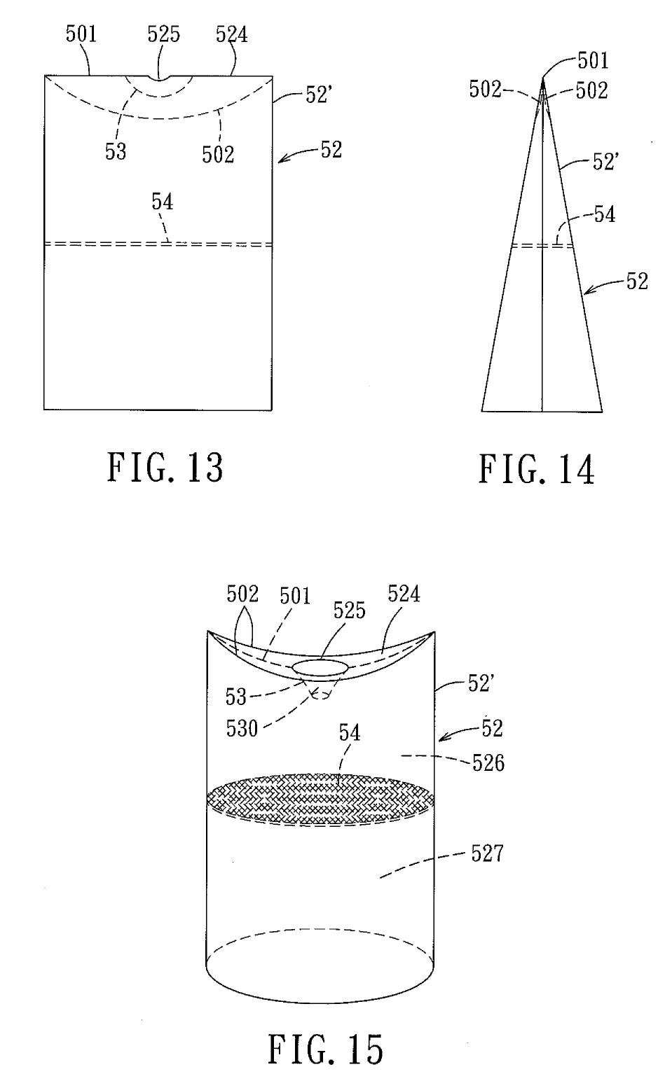

Referring to FIGS. 13 to 15, the eighth preferred embodiment of the mosquito trap differs from the previous preferred embodiments in that the container 52 includes a triangular wall body 52′ that has a foldable top wall 524 having a central folding line 501 and two opposite side folding lines 502 disposed at two opposite sides of the central folding line 501, and that the foldable top wall 524 is foldable along the central and side folding lines 501, 502 between a folded state (see FIGS. 13 and 14), where the central folding line 501 is disposed above the side folding lines 502, and an extended state (see FIG. 15), where the central and side folding lines 501, 502 are disposed at the same plane and where the foldable top wall 524 defines the top opening 525 of the container 52. In this embodiment, the restricting member 53 extends from a periphery of the top opening 525 into the first chamber 526, defines the channel 530 in fluid communication with the top opening 525 of the container 52 and the first chamber 526, and that is foldable.

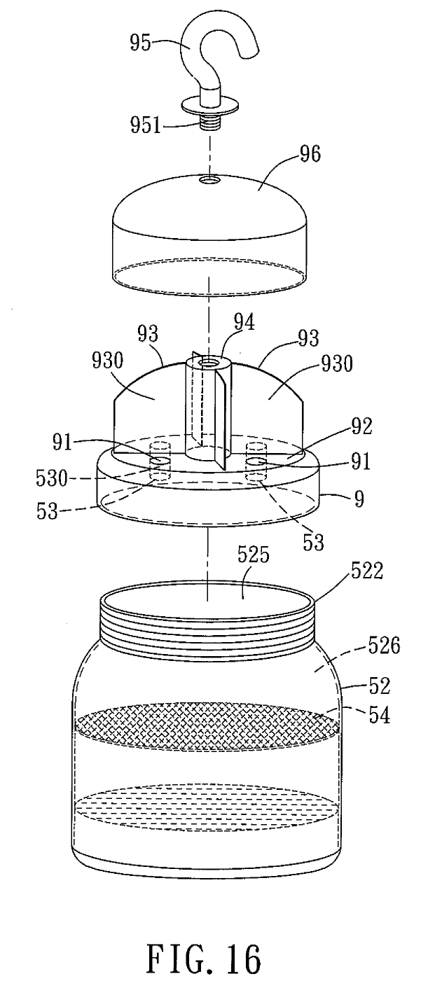

Referring to FIG. 16, the ninth preferred embodiment of the mosquito trap differs from the previous preferred embodiments in that a cap 9 is mounted on the top open end 522 of the container 52 and formed with a plurality of through-holes 91, and a plurality of restricting members 53, each of which extends from a periphery of a respective one of the through-holes 91 in the cap 9, and each of which defines a channel 530 in fluid communication with the top opening 525 of the container 52 and the first chamber 526. In this embodiment, the cap 9 has a top end wall 92 that is formed with a plurality of partitioning plates 93 which cooperatively define a plurality of compartments 930 thereamong. Each of the compartments 930 is in fluid communication with a respective one of the through-holes 91 in the cap 9, and serves to trap mosquito therein. The top end wall 92 of the cap 9 is further formed with a threaded protrusion 94. A hook 95 has a threaded stem 951 engaging the threaded protrusion 94 so as to provide a hanging function. A cover 96 is provided on the cap 9, is seated on the partitioning plates 93, and is spaced apart from the top end wall 92 of the cap 9 so as to facilitate trapping of mosquito in each of the compartments 930.

With the inclusion of the perforated plate 54 in the mosquito trap of this invention, the aforesaid drawback associated with the prior art can be eliminated.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A mosquito trap comprising:
a container defining an inner space therein and having a top opening in fluid communication with said inner space and adapted for entrance of mosquito therethrough and into said inner space;
a perforated plate mounted in said container, dividing said inner space into first and second chambers, and formed with a plurality of apertures in fluid communication with said first and second chambers; and
a carbon dioxide generating attractant disposed in said second chamber of said container.

2. The mosquito trap as claimed in claim 1, wherein said perforated plate is in the form of a screen, said first chamber being disposed above said second chamber.

3. The mosquito trap as claimed in claim 1, wherein said container further has a top open end that defines said top opening, said mosquito trap further comprising a restricting member extending inwardly from said top open end of said container and defining a channel that has a cross-section smaller than that of said top opening and that is in fluid communication with said first chamber in said container and said top opening of said container.

4. The mosquito trap as claimed in claim 3, wherein said channel is defined by a channel-defining wall that has funnel shape.

5. The mosquito trap as claimed in claim 3, wherein said channel is defined by a channel-defining wall that is cylindrical in shape.

6. The mosquito trap as claimed in claim 3, wherein said channel is defined by a channel-defining wall that has an inner surface facing said perforated plate, said mosquito trap further comprising an adhesive coated on said inner surface of said channel-defining wall.

7. The mosquito trap as claimed in claim 1, further comprising an outer can and a heater, said container being disposed in said outer can, said outer can having a bottom wall, said container having a bottom wall that has a concave portion which cooperates with said bottom wall of said outer can to define a gap therebetween, said heater being disposed in said gap for heating said carbon dioxide generating attractant.

8. The mosquito trap as claimed in claim 7, wherein said heater is in the form of a warmer pad containing a heat generating material which generates heat when triggered.

9. The mosquito trap as claimed in claim 7, wherein said container further has an inner surface having an upper portion disposed above said perforated plate and coated with an adhesive.

10. The mosquito trap as claimed in claim 7, further comprising an electric capturing screen mounted in said outer can and disposed above said container, and a power supply unit mounted on said outer can and connected electrically to said electric capturing screen.

11. The mosquito trap as claimed in claim 7, wherein said outer can further has an open end opposite to said bottom wall of said outer can and defining a top opening of said outer can, said outer can further having a lid connected removably to and extending inwardly from said open end for covering said top opening of said outer can.

12. The mosquito trap as claimed in claim 11, wherein said outer can further has an incision formed between said lid and said open end of said outer can so as to permit removal of said lid from said outer can, and a pull ring provided on said lid so as to facilitate removal of said lid from said outer can.

13. The mosquito trap as claimed in claim 11, wherein said lid has upper and lower parts that overlap each other and that are rotatable relative to each other between open and closed positions, each of said upper and lower parts being formed with a plurality of holes, said holes in said upper part being aligned with said holes in said lower part when said upper and lower parts are disposed at the opened position, and being misaligned with said holes in said lower part when said upper and lower parts are disposed at the closed position.

14. The mosquito trap as claimed in claim 13, wherein said outer can further has an upper end portion that is disposed above said container and that is formed with a plurality of angularly displaced air inlet holes, said mosquito trap further comprising a fan unit mounted in said outer can above said air inlet holes.

15. The mosquito trap as claimed in claim 4, wherein said perforated plate is generally U-shaped and extends from said open end of said container.

16. The mosquito trap as claimed in claim 1, wherein said container includes a bellow wall body that defines said inner space and that is formed with a plurality of pleated portions so as to permit expansion and contraction of said container.

17. The mosquito trap as claimed in claim 1, wherein said container includes a triangular wall body that has a foldable top wall having a central folding line and two opposite side folding lines disposed at two opposite sides of said central folding line, said foldable top wall being foldable along said central and side folding lines between a folded state, where said central folding line is disposed above said side folding lines, and an extended state, where said central and side folding lines are disposed at the same plane and where said foldable top wall defines said top opening of said container.

18. The mosquito trap as claimed in claim 17, further comprising a restricting member that extends from a periphery of said top opening into said first chamber, that defines a channel in fluid communication with said top opening of said container and said first chamber, and that is foldable.

19. The mosquito trap as claimed in claim 1, wherein said container further has a top open end defining said top opening, said mosquito trap further comprising a cap mounted on said container and formed with a plurality of through-holes, and a plurality of restricting members, each of which extends from a periphery of a respective one of said through-holes in said cap, and each of which defines a channel in fluid communication with said top opening of said container and said first chamber.

20. The mosquito trap as claimed in claim 19, wherein said cap has a top end wall that is formed with a plurality of partitioning plates which cooperatively define a plurality of compartments thereamong, each of said compartments being in fluid communication with a respective one of said through-holes in said cap.

21. The mosquito trap as claimed in claim 19, wherein said top end wall of said cap is further formed with a threaded protrusion, said mosquito trap further comprising a hook having a threaded stem engaging said threaded protrusion.
